(19) United States
(12) Patent Application Publication
(10) Pub. No.: US 2014/0343709 A1
(43) Pub. Date: Nov. 20, 2014

(54) METHOD FOR CONFIGURING AND/OR CHECKING THE OPERABILITY OF A MACHINE HAVING A GEARBOX, AND CONTROL PROGRAMME

(71) Applicant: Siemens Aktiengesellschaft, Muenchen (DE)

(72) Inventors: Georg Boeing, Rottenburg (DE); Ulrike Tschepa, Rottenburg (DE)

(21) Appl. No.: 14/345,165

(22) PCT Filed: Aug. 15, 2012
(86) PCT No.: PCT/EP2012/065962

§ 371 Date: Mar. 14, 2014

(30) Foreign Application Priority Data
Sep. 15, 2011 (EP) 11181435.6

(51) Int. Cl. G05B 19/04; G06F 17/50

(52) U.S. Cl. CPC G05B 19/0405; G06F 17/50; G05B 2219/25056
USPC 700/98

(57) ABSTRACT

In order to provide information for the functioning of housing bores or openings on a gearbox, pictograms are displayed on each housing bore or opening on a graphic user interface depending on the installation position, said pictograms displaying the respective functioning of the individual housing bores or openings.

### DE 10 2004 030 032 A1 discloses a method for configuring and parameterizing an automatable machine, wherein different technology objects are graphically represented as model components. A mechatronic signal flow between technology objects is defined on a graphical user interface by means of connections which link inputs and outputs of technology objects.

U.S. Pat. No. 4,964,043 describes a system for visualizing, identifying and ordering gearing configurations. The system comprises a computer device and an associated display device on which a selected gearing configuration is visualized. The selected gearing configuration is displayed in different orientations supplemented by descriptors or identifiers. Information to be displayed on the display device is retrieved by the computer device from a database using identifiers and provided on the display device. The display device and the computer device are disposed remotely from one another and interconnected by a communications network.

U.S. Pat. No. 5,367,627 discloses a data processing system having a storage unit in which text and graphics information concerning products administered by the data processing system is stored. This text and graphics information includes, for example, product specifications, features or advantages. The data processing system has an associated display unit on which parts of the text and graphics information are selectively displayed for information and reference purposes. To this end, a menu-driven selection function is provided which allows navigation through the text and graphics information on the basis of product specifications.

Geared motors have a large number of housing openings or bores which have different functions depending on mounting position, e.g. for oil drainage, ventilation or oil level inspection. Information about the respective function can be obtained from catalogs and operating instructions. However, the process of selecting this information constitutes a possible source of error which can result in incorrect function assignments.

The object of the present invention is to specify a method for configuring or checking the operability of a machine having a gearbox, said method enabling sources of error due to incorrect function assignments to be reduced, and to specify a technical implementation of the method.

This object is achieved according to the invention by a method having the features set forth in claim 1 and by a control program having the features set forth in claim 7. Advantageous developments of the present invention are detailed in the dependent claims.

For configuring or checking the operability of a machine having a gearbox, a three-dimensional image of a gearbox to be installed in a machine is inventively stored in a control file. The image in the control file is assigned metadata which characterizes mounting-position-dependent functions of housing bores or openings assigned to a gearbox lubricant supply system. The mounting-position-dependent functions of the housing bores or openings assigned to the gearbox lubricant supply system can be e.g. ventilation, lubricant drainage and lubricant level inspection. The control file is loaded into a computer-based configuring or operability checking unit to which a graphical user interface is assigned. In addition, a gearbox contained in the control file is displayed on the graphical user interface in a configurable manner in respect of its mounting position predefined by its position or orientation. In response to a user input of a selected mounting position, the gearbox contained in the control file is displayed on the graphical user interface using pictograms on the housing bores or openings for matching to permissible connection areas of the machine. Said pictograms each visualize a housing bore or opening function assigned to the selected mounting position. In this way, incorrect function assignments can be eliminated.

According to a preferred embodiment of the present invention, the pictograms visualizing the mounting-position-dependent functions are displayed positioned on plug screws of the housing bores or openings on the graphical user interface. This allows particularly rapid and reliable function assignment. According to an alternative embodiment of the present invention, pictograms visualizing mounting-position-dependent functions can also be displayed positioned adjacent to plug screws.

The three-dimensional image of the gearbox is preferably stored as object data in the control file. According to a further development of the present invention, the control file is additionally loaded into the configuring or operability checking unit together with object data representing the configuration of the machine and displayed on the graphical user interface. In this way, positions of housing bores or openings can be particularly reliably and simply matched to permissible connection areas of the machine.

In addition, the configuring or operability checking unit can be assigned, for example, to a server processing unit, while the graphical user interface can be assigned to a client processing unit. In this case the server processing unit and client processing unit are interconnected via a communications network. This ensures efficient and consistent provision of information concerning functions of housing bores or openings on a gearbox or geared motor.

The present invention will now be explained in greater detail with reference to the accompanying drawings in which:

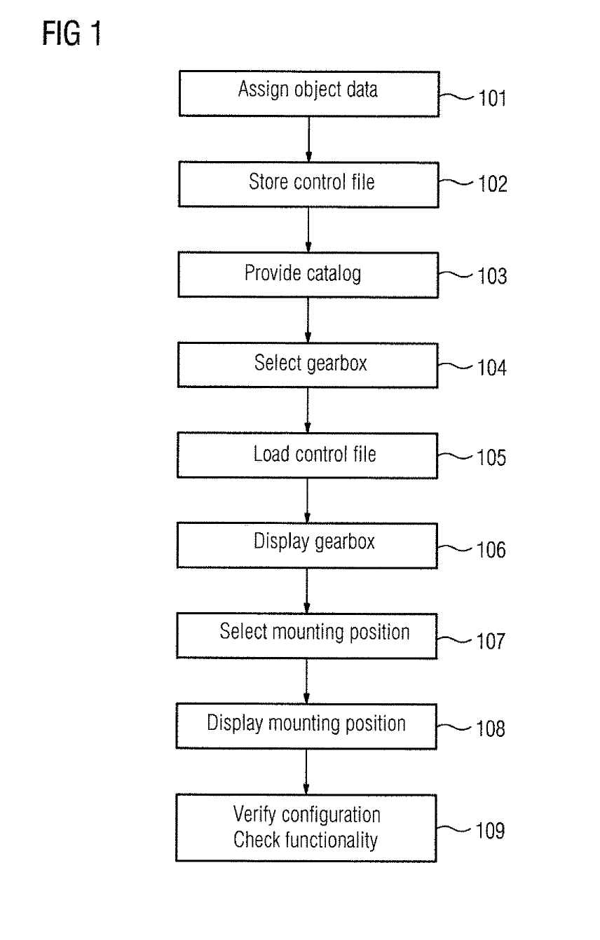

FIG. 1 shows a flow chart for configuring and checking the operability of a machine having a gearbox,

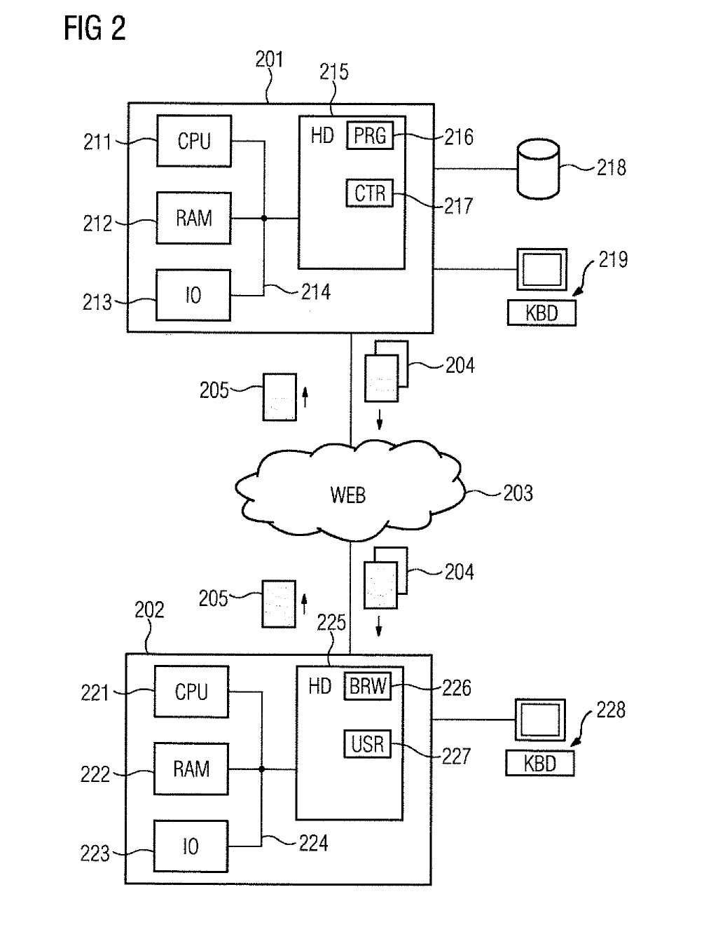

FIG. 2 shows an example of a system for carrying out the method illustrated in FIG. 1,

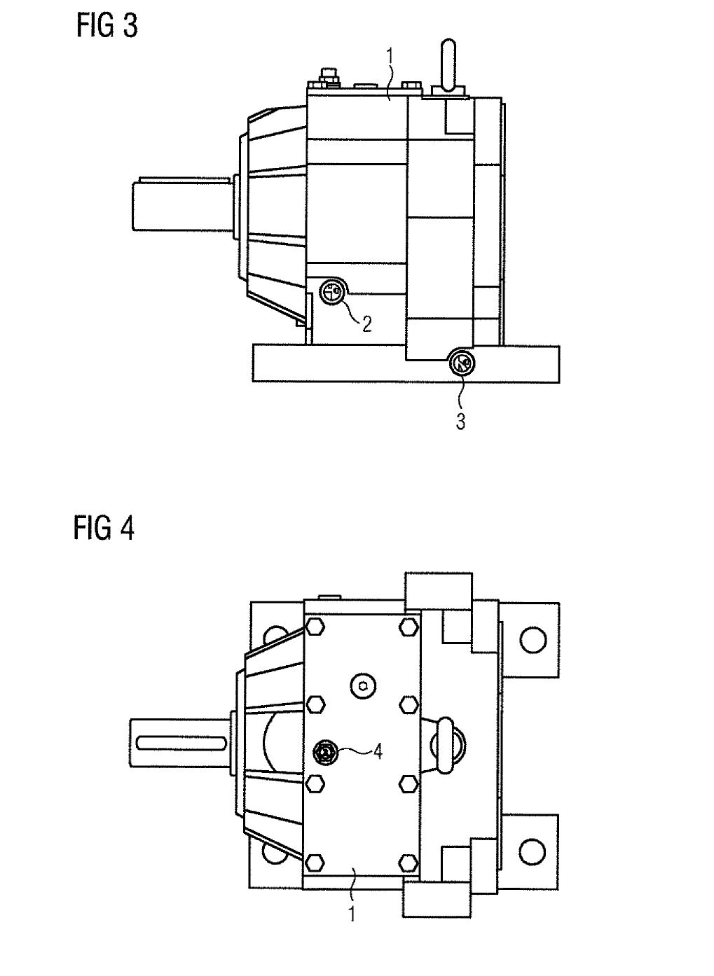

FIG. 3 shows a side view of a gearbox in a first mounting position on a graphical user interface of the system depicted in FIG. 2,

FIG. 4 shows a plan view of the gearbox according to FIG. 3 displayed on the graphical user interface in the first mounting position,

FIG. 5 shows a view from below of the gearbox displayed on the graphical user interface in a second mounting position,

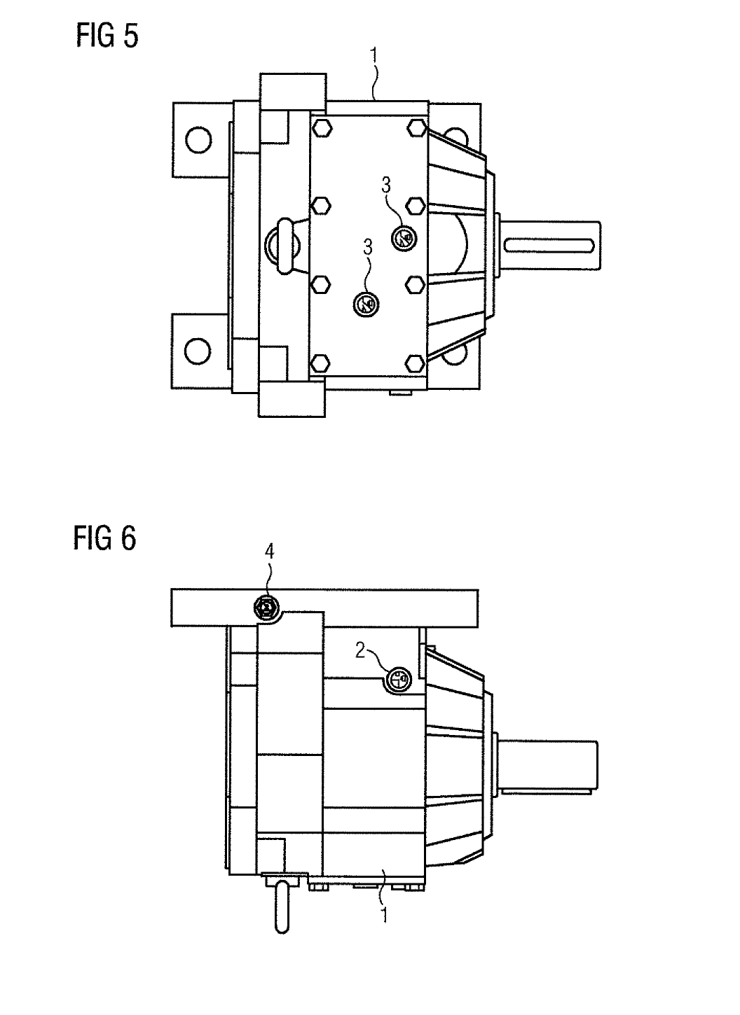

FIG. 6 shows a side view of the gearbox according to FIG. 5 displayed on the graphical user interface at the second mounting position,

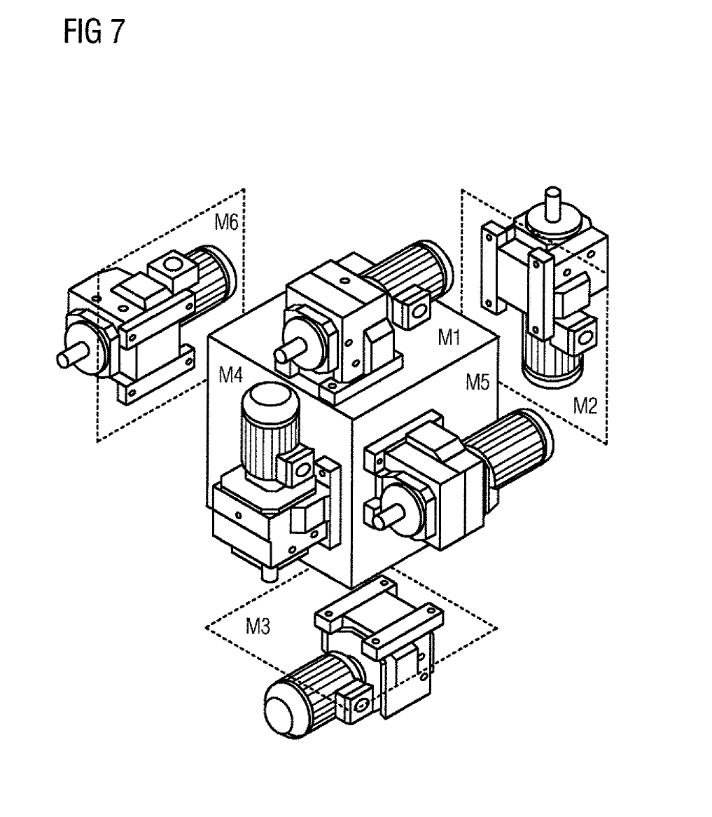

FIG. 7 shows an overview of a total of 6 mounting positions of a geared motor.

According to the flow chart shown in FIG. 1 for configuring or checking the operability of a machine having a gearbox, object data representing a three-dimensional image of the gearbox is assigned to metadata (step 101) which characterizes the mounting-position-dependent functions of housing bores or openings assigned to a gearbox lubricant supply system. In this example, the mounting-position-dependent functions of the housing bores or openings assigned to the gearbox lubricant supply system are ventilation, lubricant drainage and lubricant level inspection. After assignment of metadata and object data, these are stored according to step 102 in a control file which forms the basis for providing a catalog (step 103) containing a plurality of gearbox types or models. An example of such a catalog is the internet-based eKat design catalog system which is used for creating, storing and displaying design catalogs. Design catalogs are knowledge stores created from a methodological standpoint which are systematically organized within a certain framework and allow selective access to their contents. Design catalogs are also used for suggesting or adopting solutions by systematic assignment of known solution features to conditions of particular performance requirements. For example, information about physical effects, operating principles, basic solutions for complex tasks, machine elements, standard parts or materials is stored in design catalogs.

In this example, the catalog is provided on a graphical user interface 228 shown in FIG. 2 of a client processing unit 202 by a server processing unit 201 for selecting a gearbox to be installed in a machine according to step 104. In a single workstation variant, the catalog can basically also be provided on a graphical user interface 219 of the server processing unit 201.

The server processing unit 201 and client processing unit 202 are interconnected via a communications network 203, e.g. the Internet. When a gearbox is selected, an associated control file 217 is loaded into the server processing unit 201 as a configuring or operability checking unit (step 105). In step 106 the gearbox contained in the control file 217 is then displayed on the graphical user interface 228 of the client processing unit 202 in a configurable manner in respect of its mounting position predefined by its position or orientation. In response to selection of a desired mounting position according to step 107, the gearbox contained in the control file 217 is displayed on the graphical user interface 228 using pictograms on the housing bores or openings (step 108). In this example the pictograms 2-4 on the graphical user interface are displayed positioned on plug screws of the housing bores or openings. Alternatively to being displayed on plug screws, the pictograms 2-4 can also be displayed in the vicinity of plug screws. According to step 109 of the flow chart shown in FIG. 1, as part of verification of the gearing configuration or of operability checking, the housing bores or openings are then matched to permissible connection areas of the machine.

According to FIGS. 3-6, the pictograms 2-4 each visualize a function of the housing bores or openings of the gearbox 1 that is assigned to the mounting position selected. In the case of the first mounting position shown in FIGS. 3 and 4, a gearbox serving as an example is mounted on a horizontal surface. In contrast, in the case of the second mounting position shown in FIGS. 5 and 6, the gearbox is mounted below a horizontal surface. According to the overview shown in FIG. 7, comprising a total of 6 mounting positions M1-M6 of a geared motor containing a gearbox, the geared motor can basically be mounted on a lateral surface of a virtual cube in each case. A mounting position M1-M6 is here assigned to each lateral surface.

In FIGS. 3-6, a first pictogram 2 symbolizes a lubricant level inspection hole, a second pictogram 3 a lubricant drain hole and a third pictogram 4 a vent hole. According to the first mounting position shown in FIGS. 3 and 4, the lubricant level inspection hole and lubricant drain hole are disposed on the same side of the housing, whereas the vent hole is provided on an adjacent side of the housing. In the case of the second mounting position shown in FIGS. 5 and 6, the vent hole and lubricant level inspection hole are disposed on the same side of the housing, whereas two lubricant drain holes are provided on an adjacent side of the housing.

The above described method is preferably implemented by a control program 216 which can be loaded into a main memory 212 of the server processing unit 201 and has at least one code segment that can be processed by a processor 211 of the server processing unit 201. On execution of said code segment, steps 101-109 of the flow chart shown in FIG. 1 are carried out when the control program 216 is run in the server processing unit 201. The server processing unit 201 additionally comprises an input/output unit 213 linked to the graphical user interface 219, and a bus system 214 which is accessed by the processor 211, main memory 212 and input/output unit 213. The control program 216 and the control file 217 are persistently stored on a hard disk 215 of the server processing unit 201. Extensive catalogs containing gearboxes can also be stored in a separate database 218 which is assigned to the server processing unit 201.

The client processing unit 202 likewise comprises a processor 221, a main memory 222, an input/output unit 223, a bus system 224 and a hard disk 225. Stored on the hard disk 225 is a browser program 226 for displaying catalog contents 204 provided by the server processing unit 201 via the communications network 203, and a user-specific control file 227 containing object data representing a configuration of the machine. To control catalog contents 204 provided by the server processing unit 201, the client processing unit 202 transmits appropriate control commands 205 to the server processing unit 201 via the communications network 203. The user-specific control file 227 can also be loaded into the server processing unit 201 as a configuring or operability checking unit together with the control file 217 via the communications network 203.

The application of the present invention is not limited to the exemplary embodiment described.

1-7. (canceled)

8. A method for at least one of configuring and checking operability of a machine having a gearbox, comprising:
storing in a control file a three-dimensional image of a gearbox to be installed in the machine, wherein in the control file metadata identifying mounting-position-dependent functions of housing bores or housing openings associated with a lubricant supply system of the gearbox are associated with the three-dimensional image,
loading the control file into a computer-based configuration or operability checking unit with which a graphical user interface is associated,
displaying on the graphical user interface the gearbox contained in the loaded control file in a manner that allows a mounting position of the gearbox having a predefined position or orientation to be configured,
in response to a user input of a selected mounting position, displaying the gearbox contained in the control file on the graphical user interface using pictograms on the housing bores or the housing openings for matching to permissible connection areas of the machine, wherein the pictograms each visualize a respective function of the housing bores or housing openings associated with the selected mounting position.

9. The method of claim 8, further comprising
storing the three-dimensional image of the gearbox as object data in the control file,
loading the control file into the configuration or operability checking unit together with object data representing a machine configuration, and
displaying the loaded control file on the graphical user interface.

10. The method of claim 8, wherein the mounting-position-dependent functions of the housing bores or housing openings associated with the lubricant supply system of the gearbox comprise ventilation, lubricant drainage and lubricant level inspection.

11. The method of claim 10, wherein the pictograms displaying the mounting-position-dependent functions on the graphical user interface are displayed in a position on top of plug screws of the housing bores or housing openings.

12. The method of claim 10, wherein the pictograms displaying the mounting-position-dependent functions on the graphical user interface are displayed in a position adjacent to plug screws of the housing bores or housing openings.

13. The method of claim 8, wherein the configuration or operability checking unit is associated with a server processing unit, wherein the graphical user interface is associated with a client processing unit, and wherein the server processing unit and the client processing unit are interconnected via a communications network.

14. A control program embodied in a computer-readable non-transitory medium and stored in a memory of a processing unit, said control program comprising at least one code segment that, when executed by a processor of the processing unit, causes the processing unit to
store in a control file a three-dimensional image of a gearbox to be installed in the machine, wherein in the control file metadata identifying mounting-position-dependent functions of housing bores or housing openings associated with a lubricant supply system of the gearbox are associated with the three-dimensional image,
load the control file into a computer-based configuration or operability checking unit with which a graphical user interface is associated,
display on the graphical user interface the gearbox contained in the loaded control file in a manner that allows a mounting position of the gearbox having a predefined position or orientation to be configured,
in response to a user input of a selected mounting position, display the gearbox contained in the control file on the graphical user interface using pictograms on the housing bores or the housing openings for matching to permissible connection areas of the machine, wherein the pictograms each visualize a respective function of the housing bores or housing openings associated with the selected mounting position.
